(19) United States
(12) Patent Application Publication
(10) Pub. No.: US 2019/0244540 A1
(43) Pub. Date: Aug. 8, 2019

(54) Systems And Methods For Providing Performance Training and Development

(71) Applicant: InnerPro Sports, LLC, St. Louis, MO (US)

(72) Inventors: Eric ERRANTE, St. Louis, MO (US); Stephen DOWNEY, St. Louis, MO (US); Jennifer ERRANTE, St. Louis, MO (US)

(21) Appl. No.: 16/265,574

(22) Filed: Feb. 1, 2019

Related U.S. Application Data
(60) Provisional application No. 62/625,810, filed on Feb. 2, 2018.

(51) Int. Cl. G09B 19/00; A63B 24/00; G09B 5/06

(52) U.S. Cl. CPC G09B 19/00; G09B 19/0092; G09B 5/065; A63B 24/0062; A63B 24/0075

(57) ABSTRACT

According to various aspects, disclosed are exemplary embodiments of systems and methods for providing performance training and development.

### CROSS-REFERENCE TO RELATED APPLICATION

This application claims priority to and the benefit of U.S. Provisional Patent application No. 62/625,810 filed Feb. 2, 2018. The entire disclosure of the above application is incorporated herein by reference.

### FIELD

The present disclosure generally relates to systems and methods for providing performance training and development.

### BACKGROUND

This section provides background information related to the present disclosure which is not necessarily prior art.

Athletic excellence does not come easily to most athletes. Athletes who wish to excel in their chosen sport typically follow the same strategy: to work hard, practice often and compete hard against other athletes.

### DRAWINGS

The drawings described herein are for illustrative purposes only of selected embodiments and not all possible implementations, and are not intended to limit the scope of the present disclosure.

FIG. 1 is a diagram of a traditional athletic centralized model, which may be used by teams to drive higher levels of performance.

FIG. 2 is a diagram of an example system for providing performance training, the system embodying one or more aspects of the present disclosure.

FIGS. 3 through 8 illustrate diagrams of an example system for providing performance training and development, the system embodying one or more aspects of the present disclosure.

FIGS. 9 through 23 illustrate example screenshots of displays provided on user devices in accordance with various implementations of the disclosure.

### DETAILED DESCRIPTION

Example embodiments will now be described more fully with reference to the accompanying drawings.

Athletes who are striving to improve their skills typically need tools, strategies and information by which to train effectively. Many athletes who wish to excel, however, do not have access to effective coaching. Although athletes' mental performance is often discussed and is considered important to athletic success, there are few, if any, athletes who actually train to improve their mental performance. Instead, many athletes tend to have no strategy for training, except to practice, compete, and hope for the best.

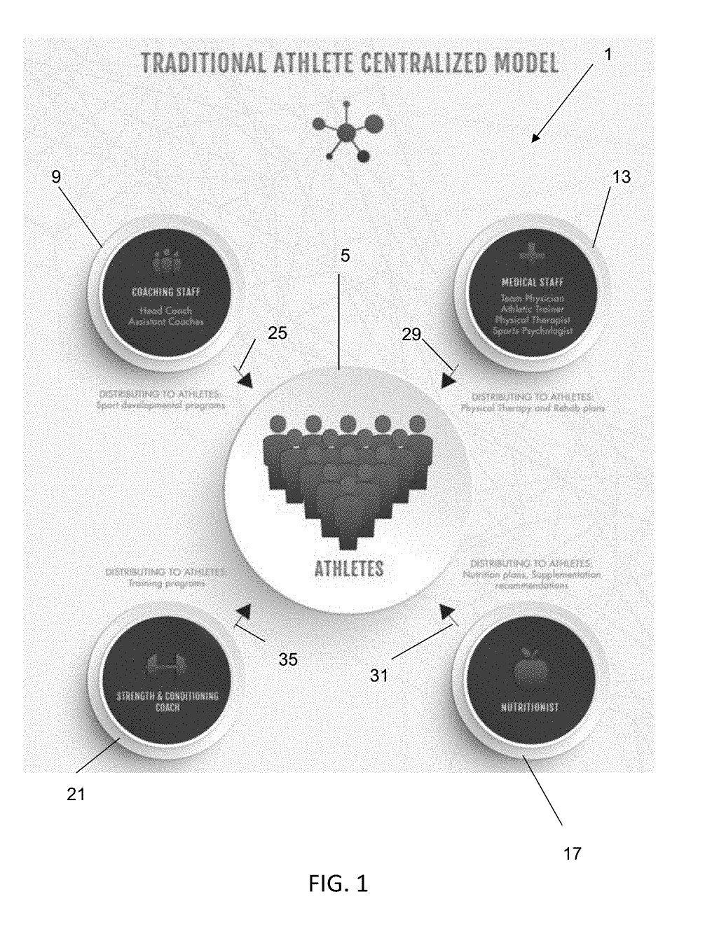

FIG. 1 is a diagram of a traditional athletic centralized model 1, which may be used by teams to drive higher levels of performance. This traditional model centralizes the athlete as its primary focus. But this presents inefficiencies within the traditional model due to the high ratio of athletes to coaches.

As shown in FIG. 1, the athletes 5 are represented in the middle. Along the outside are the coaching staff 9 (head coach, assistant coaches), medical staff 13 (team physician, athletic trainer, physical therapist, sports psychologist), nutritionist 17, and strength & conditioning coach 21. The arrow 25 represents one-way communication from the coaching staff 9 (distributing sports development programs) to the athletes 5. The arrow 29 represents one-way communication from the medical staff 13 (distributing physical therapy and rehab plans) to the athletes 5. The arrow 31 represents one-way communication from the nutritionist 17 (distributing nutrition plans, supplementation recommendations) to the athletes 5. The arrow 35 represents one-way communication from the strength & conditioning coach 21 (distributing training programs) to the athletes 5.

Some of the challenges associated with the high athlete-to-coach ratio of the traditional model include customization, accountability, and communication. For example, customization is a challenge because with a high athlete-to-coach ratio, the ability to customize specific developmental programs for each athlete diminishes.

Accountability is a challenge because with a high athlete-to-coach ratio, athlete accountability also decreases. And, it becomes increasingly difficult to monitor who is putting in the work and who isn't, especially during an athlete's off-season when the athlete is not with the team.

Communication is a challenge because with a high athlete-to-coach ratio, critical communication has a higher tendency to break down. Common examples include player injuries, difficult exercises, and misalignment. For example, an injured athlete may communicate the injury to the trainer. But the extent of the injury and/or the plan for rehabilitation may be misconstrued between the Medical Staff, Training Staff, and Athlete.

Regarding difficult exercises, an athlete may struggle to perform a high risk strength training exercise and communicate this to the coach. But the coach may fail to communicate this to the Strength and Conditioning coach.

Regarding misalignment, the Strength Coach and Athlete may decide to change a player's plan to focus on increasing size and muscle mass. The Nutritionist, however, may not be made aware of these changes. And, the current Nutrition plan may be focused on maintenance and remain active.

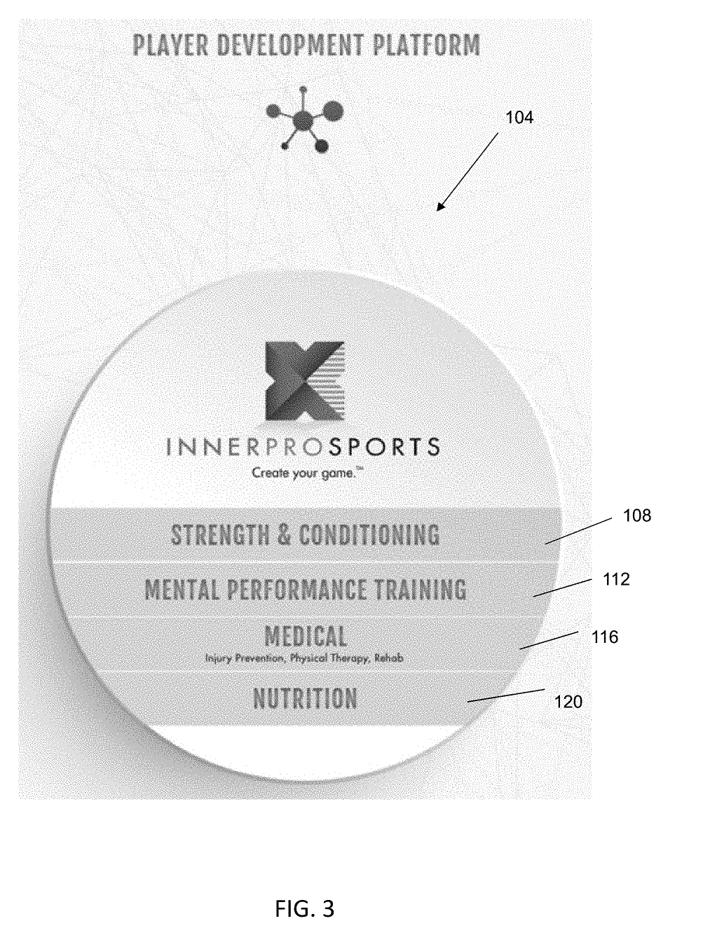

Accordingly, the inventors have developed and disclose herein exemplary embodiments of systems and methods for providing performance training and development. In exemplary embodiments (see, e.g., central distribution hub 104 in FIG. 3, etc.), this may include providing strength training and conditioning 108, mental performance training 112, medical 116 (e.g., injury prevention, physical therapy, rehabilitation, etc.), and nutrition 120.

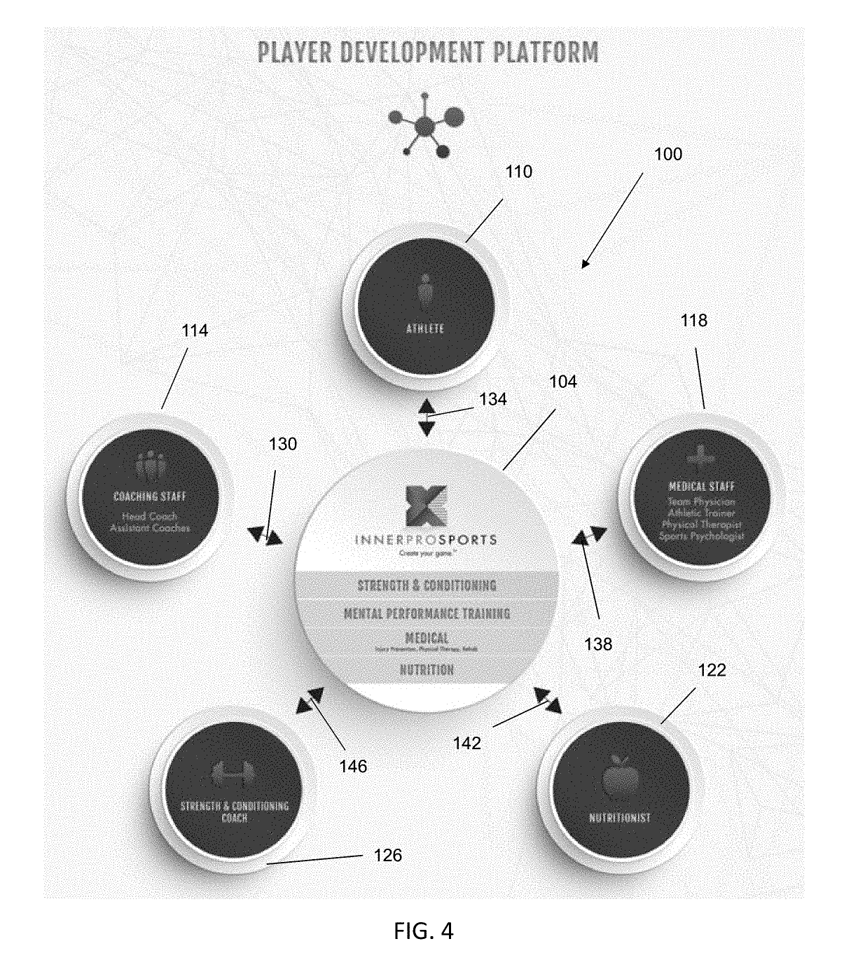

FIGS. 4 through 8 illustrate an exemplary embodiment of a system 100 embodying one or more aspects of the present disclosure. As shown, the athlete 110 has been removed from the center of the system 100 and replaced with a central distribution hub 104. The athlete 110 shown along a perimeter or outside with the coaching staff 114 (head coach, assistant coaches), medical staff 118 (team physician, athletic trainer, physical therapist, sports psychologist), nutritionist 122, and strength & conditioning coach 126.

In FIG. 4, the arrow 130 represents two-way communication between the central distribution hub 104 and the coaching staff 114 (e.g., for distributing sports development programs, etc.). The arrow 134 represents two-way communication between the central distribution hub 104 and the athlete 110. The arrow 138 represents two-way communication between the central distribution hub 104 and the medical staff 118 (e.g., for distributing physical therapy and rehab plans, etc.) The arrow 142 represents two-way communication between the central distribution hub 104 and the nutritionist 112 (e.g., for distributing nutrition plans, supplementation recommendations, etc.). The arrow 146 represents two-way communication between the central distribution hub 104 and the strength & conditioning coach 126 (e.g., for distributing training programs, etc.).

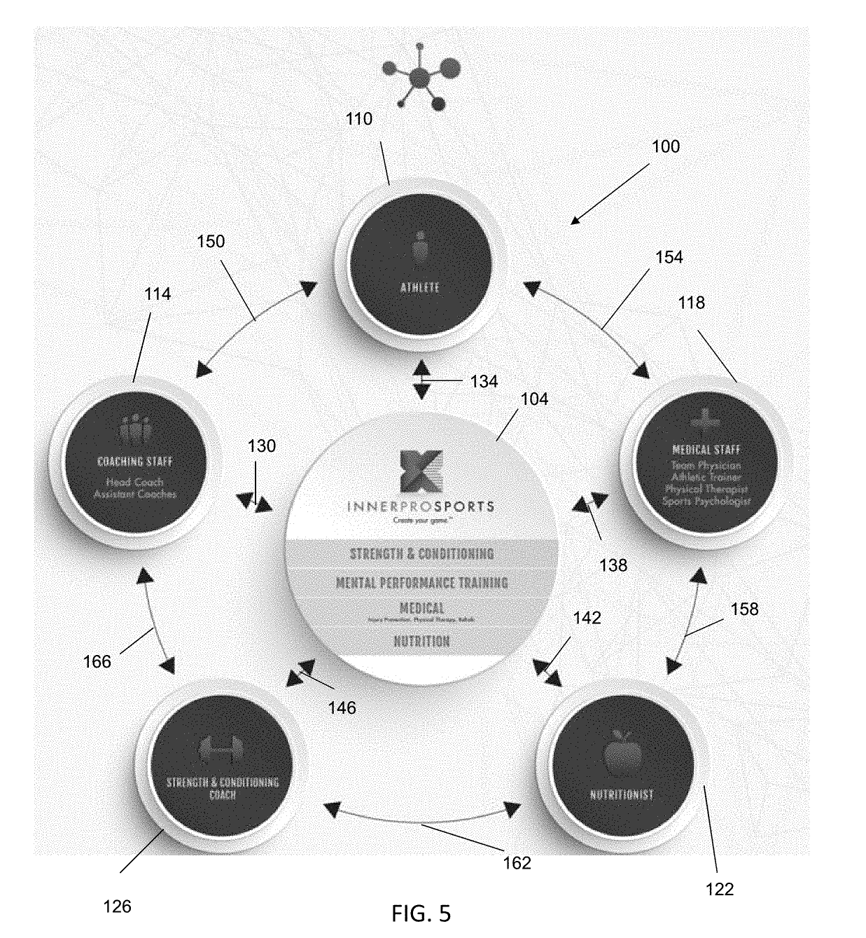

In addition to two-way communication with the central distribution hub 104 (FIGS. 3 and 4), the system 100 is also configured to allow two-way communications between the athlete 110, coaching staff 114, medical staff 118, nutritionist 122, and strength & conditioning coach 126 as represented by the arrows shown in FIG. 5. For example, the arrow 150 represents two-way communication between the coaching staff 114 and the athlete 110. The arrow 154 represents two-way communication between the athlete 110 and the medical staff 118. The arrow 158 represents two-way communication between the medical staff 118 and the nutritionist 112. The arrow 162 represents two-way communication between the nutritionist 162 and the strength & conditioning coach 126. The arrow 166 represents two-way communication between the coaching staff 114 and the strength & conditioning coach 126.

In exemplary embodiments, the central distribution hub 104 of the system 100 may be configured to allow two-way communications between all of the members. For example, the system 100 may be configured to allow two-way communication between the athlete 110 and the nutritionist 122, between the athlete 110 and the strength and conditioning coach 126, between the coaching staff 112 and the medical staff 118, between the coaching staff 112 and the nutritionist 122, between the strength and conditioning coach 126 and the nutritionist 122, etc. Accordingly, the system 100 uses the athlete's development needs and the central distribution hub 104 that connects the team (e.g., athlete 110, coaching staff 114, medical staff 118, nutritionist 122, strength & conditioning coach 126, etc.) in a unique way.

Exemplary embodiments may include systems and methods (e.g., a set of combined software applications, a software application on an athlete's smart phone or other electronic device, etc.) that may help teams improve competitive performance, such as by organizing, managing, and tracking every aspect of player development from one centralized location 104 (FIG. 3). As shown in FIG. 3, these developmental areas include Strength and Conditioning 108, Mental Performance Training 112, Medical 116 (Injury Prevention, Physical Therapy, Rehabilitation), and Nutrition 120.

With the hub 104 of athlete needs in place, every other member of the team may then be added, including the athlete 110, coaching staff 114, medical staff 118, nutritionist 122, and strength & conditioning coach 126 as shown in FIG. 4. Notably, the athlete 110 is a member of the team. By comparison, FIG. 3 shows the traditional model 1 in which the athlete 5 is the center of the hub.

As shown in FIG. 5, each of the team members (athlete 110, coaching staff 114, medical staff 118, nutritionist 122, and strength & conditioning coach 126) are connected with each other. Each of these variables are dependent upon one another and are essential elements of performance. Accordingly, the system 100 shown in FIG. 5 allows for higher levels of customization, communication, and data capture. With the centralized combination of all variables, athletes' developmental needs may be met at much higher levels, thus resulting in an improvement in athletes' overall competitive performance. The exemplary systems/methods/models disclosed herein thus provide the capabilities to create a more customized experience for athletes on a mass scale.

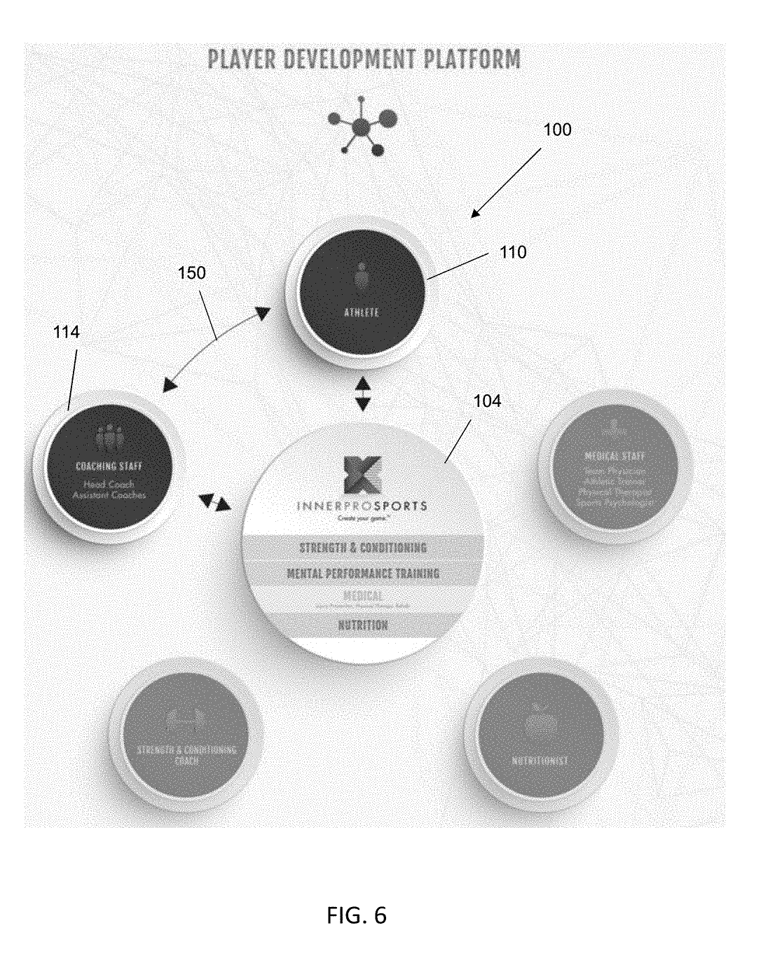

In addition, all teams are not necessarily composed of the same members. Advantageously, the exemplary systems/methods/models disclosed herein may be customized to meet any team's needs. For example, FIG. 6 illustrates the system 100 customized or configured for use by the athlete 110 and coaching staff 114 who may communicate with each other via the central distribution hub 104. The arrow 150 represents two-way communication between the coaching staff 114 and the athlete 110. In this particular example, the team does not include a medical staff 118, a nutritionist 122, or a strength & conditioning coach 126.

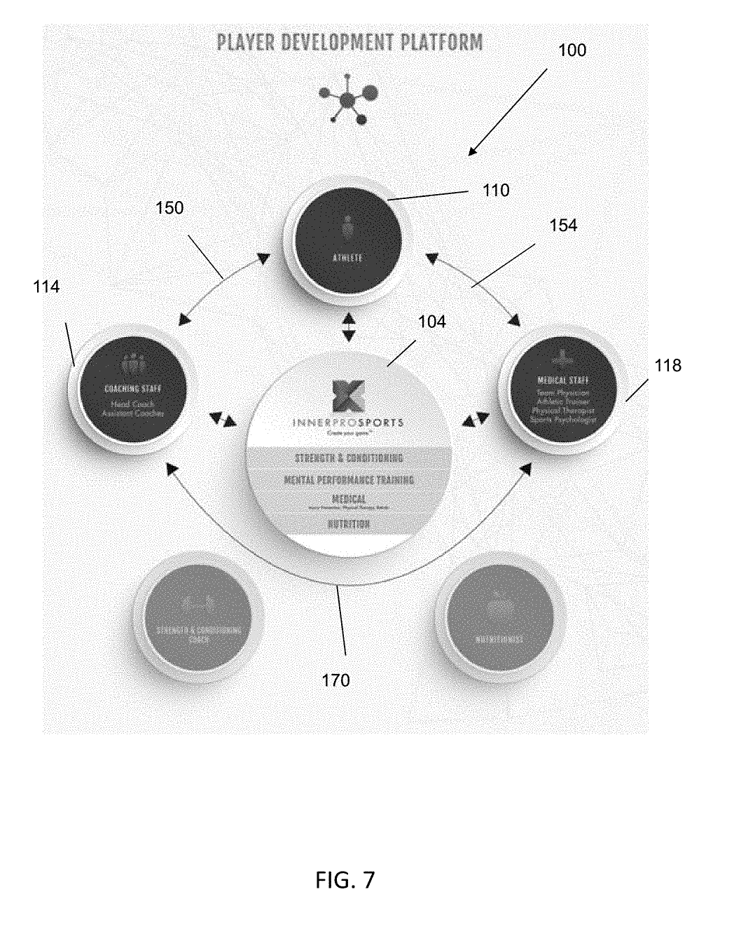

FIG. 7 illustrates the system 100 customized or configured for use by the athlete 110, coaching staff 114, and medical staff 118 who may communicate with each other via the central distribution hub 104. The arrow 150 represents two-way communication between the coaching staff 114 and the athlete 110. The arrow 154 represents two-way communication between the athlete 110 and the medical staff 118. The arrow 170 represents two-way communication between the coaching staff 114 and the medical staff 118. In this particular example, the team does not include a nutritionist 122 or a strength & conditioning coach 126.

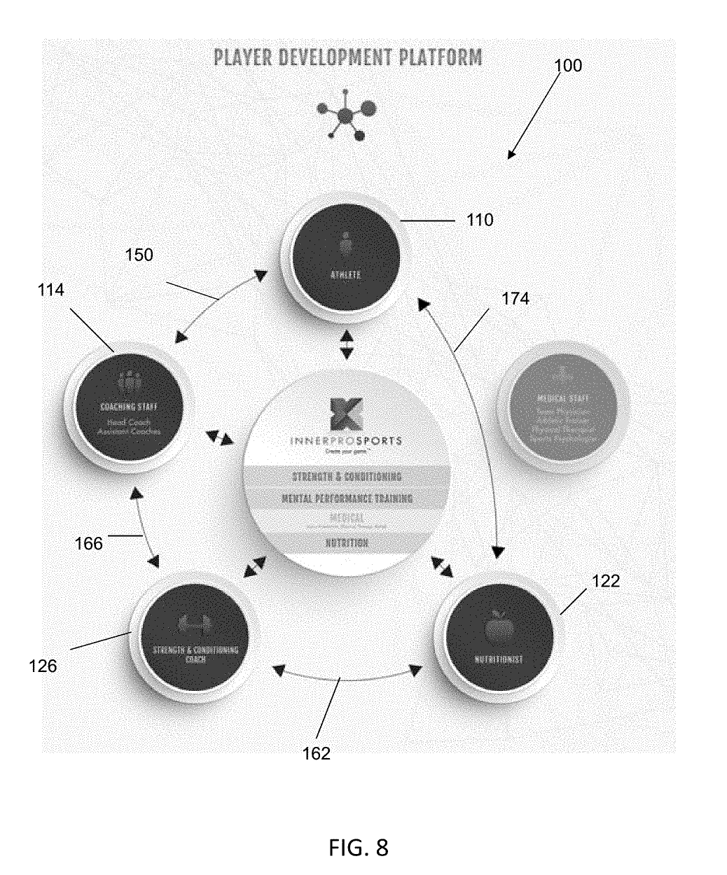

FIG. 8 illustrates the system 100 customized or configured for use by the athlete 110, coaching staff 114, nutritionist 122, and strength and conditioning coach 126 who may communicate with each other via the central distribution hub 104. The arrow 150 represents two-way communication between the coaching staff 114 and the athlete 110. The arrow 154 represents two-way communication between the athlete 110 and the medical staff 118. The arrow 162 represents two-way communication between the nutritionist 162 and the strength & conditioning coach 126. The arrow 166 represents two-way communication between the coaching staff 114 and the strength & conditioning coach 126. The arrow 174 represents two-way communication between the athlete 110 and the nutritionist 122. In this particular example, the team does not include medical staff 118.

Examples of various user types and features will now be provided by way of example only. For example, the technology used by an athlete may include a software application on an electronic device, such as a smartphone, tablet, desktop computer, laptop computer, etc. The athlete may be provided with access to the highest levels of coaching 24/7. The athlete may be provided customized training strategies designed specifically for the athlete. The athlete may also monitor their personal physical and mental training, as well as injury rehabilitation and physical therapy.

As another example, the technology used by a coaching staff may include a software application on an electronic device, such as a smartphone, tablet, desktop computer, laptop computer, etc. The coaching staff may monitor an athlete's physical and mental training history. The coaching staff may be able to determine how their team is trending in terms of their physical and mental training. The coaching staff may be updated in real time on training inconsistency and all injury situations.

By way of further example, the technology used by a strength & conditioning coach may include a strength coach software application on an electronic device, such as a smartphone, tablet, desktop computer, laptop computer, etc. The strength & conditioning coach may create, distribute and manage customized training programs for athletes on a mass scale The strength & conditioning coach may make quick and easy changes to training plans on a mass scale. The strength & conditioning coach may monitor an athlete's training history. The strength & conditioning coach may obtain real time updates on soreness, injuries and exercises that may be too difficult to perform. The strength & conditioning coach may be provided with knowledge about what the medical staff is having the athlete do during rehabilitation or physical therapy situations.

Also, by way of example, the technology used by the medical staff may include a medical software application on an electronic device, such as a smartphone, tablet, desktop computer, laptop computer, etc. The medical staff may be notified of any athlete injuries. The medical staff may create, distribute, and manage rehabilitation and physical therapy strategies. The medical staff may see an athlete's physical training history.

By way of further example, the technology used by the nutritionist may include a nutrition software application on an electronic device, such as a smartphone, tablet, desktop computer, laptop computer, etc. The nutritionist may create and distribute customized meal plans and supplementation that align with the player's physical training strategy.

Aspects of the present disclosure also relate to customizable product lines or layers, including (1) strength and conditioning, (2) mental performance training, (3) injury prevention and rehabilitation, (4) nutrition and supplementation, and (5) advanced athlete tracking.

Strength and Conditioning

Under strength and condition, a first product may include strength coach software (manual). It may be easy to use via a user dashboard. Strength and conditioning coaches may create, distribute and manage customized training programs. Distribution may occur to the athlete via a mobile app. The strength coach may have access to a comprehensive library of specific training programs and individual exercises.

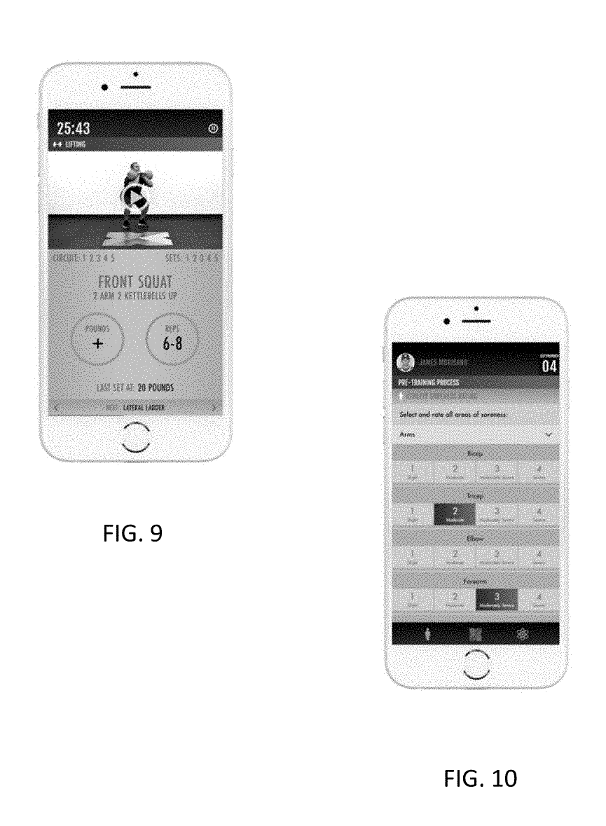

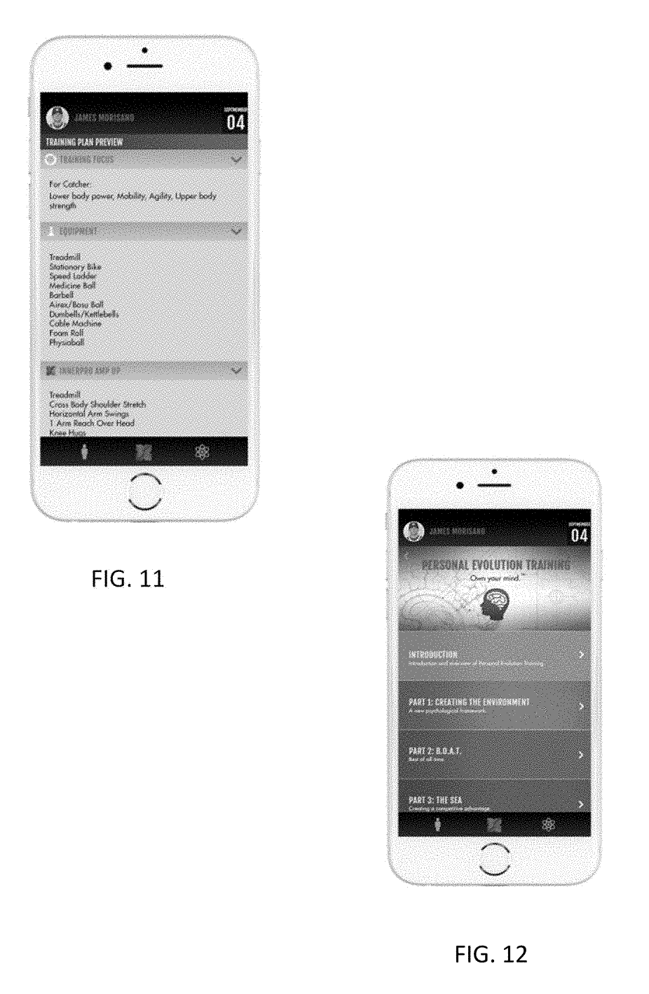

A second product may include strength and conditioning (automated) including dynamic training programs created by world class strength coach(es). See, for example, FIGS. 9-11. The dynamic training programs may uses input from the athlete(s) to determine daily prescribed exercises.

Mental Performance Training

Under mental performance training, a third product may include a library of (e.g., 33 or more, etc.) educational videos on mental performance training. See, for example, FIG. 12.

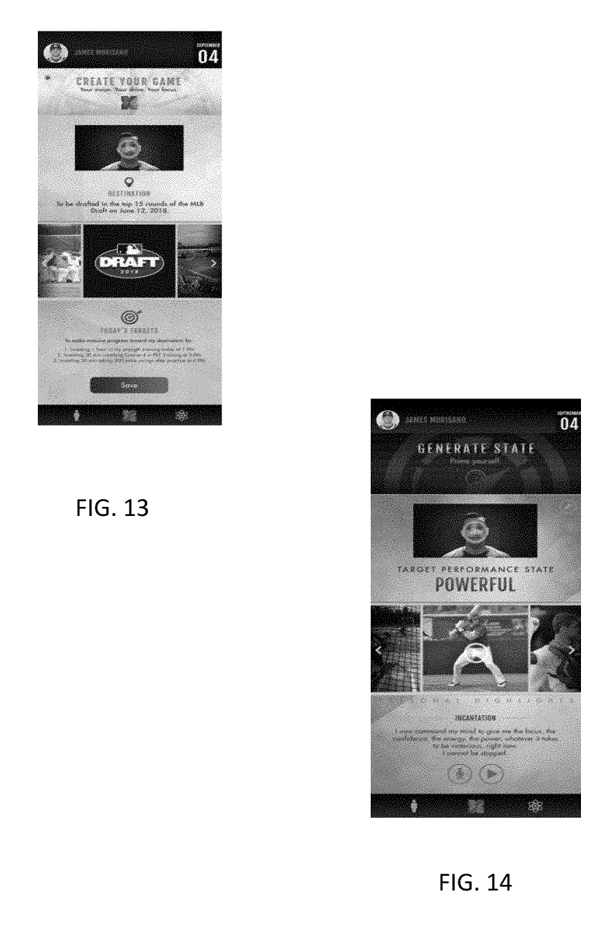

The athlete may implement what has been learned via two tools on the app. The first tool (e.g., Create Your Game in FIG. 13, etc.) may include a goal setting and daily planning tool. This may allow the athlete(s) to create a long-term vision for their game and design each day with action items to move them toward that vision.

A second tool (e.g., Generate State in FIG. 14, etc.) may include a tool used for pre-practice and pre-game preparation. Athlete(s) may reference their best performances (e.g., via images and/or videos, etc.) to create an emotional state that gives them the most access to their skills.

Injury Prevention and Rehabilitation

Under injury prevention and rehabilitation, a fourth product may include medical software (manual) that is utilized by a team's medical staff to create, distribute and manage customized rehabilitation and physical therapy programs. Distribution may occur to the athlete via the mobile app. The medical staff may have access to a comprehensive library of specific training programs and individual exercises.

Nutrition and Supplementation

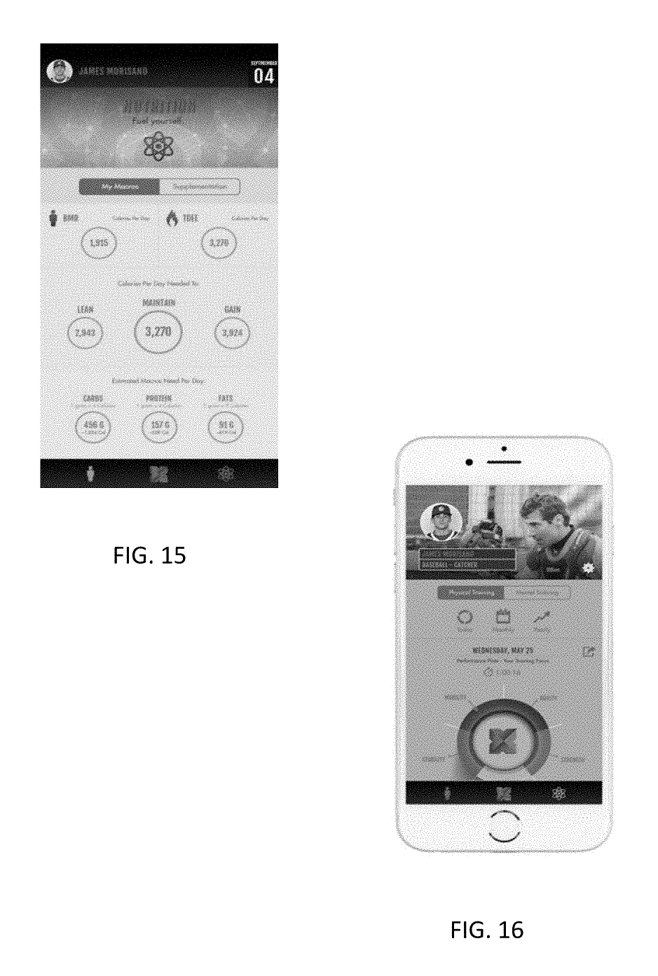

Under nutrition and supplementation, a fifth product may include nutrition basic (automated) that may include macros and supplementation recommendations based on current strength and conditioning program. See, for example, FIG. 15. By way of example, formulas references may include:

BMR=TOTAL CALORIC EXPENDITURE NEEDED TO RUN EACH DAY

MEN: 66+(6.23×weight (lbs))+(12.7×height (inches))−(6.8×age)

WOMEN: 655+(4.35×weight (lbs))+(4.7×height (inches))−(4.7×age)
Multiply Each by:
1.2=Little or no exercise/sports 0/days
1.375=light exercise/sports 1-3 days/week
1.55=moderate exercise/sports 3-5 days/week
1.725=hard exercise/sports 6-7 days/week
1.9=very hard exercise/sports 2×/day
These additions are the BMR+Harris Benedict formula based on activity level needed to run each day.
Subtract 500 calories a day to lose 1 pound of body weight a week
Subtract 1000 calories a day to lose 2 pounds of body weight a week
Add 500 calories a day to gain 1 pound of body weight a week
Add 1000 calories a day to gain 2 pounds of body weight a week

A sixth product may include nutrition software (manual) that is utilized by a team's nutritionist to create, distribute, and manage customized nutrition strategies and meal plans. The distribution may occur to the athlete via the mobile app. The nutritionist may have access to a comprehensive nutrition and supplementation library.

Advanced Athlete Tracking

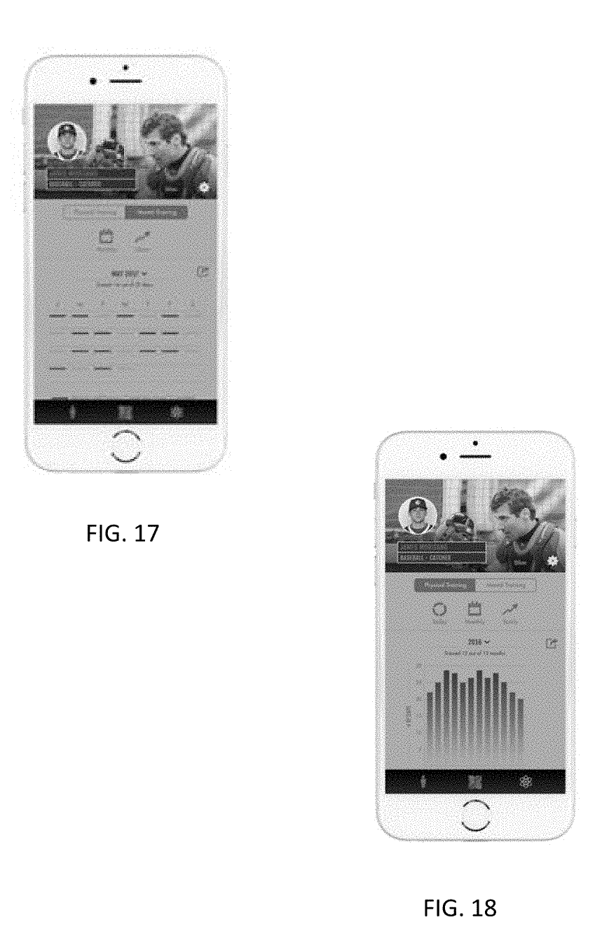

Under advanced athlete tracking, a seventh product may include athlete tracking software (for athletes) that is utilized by the athletes to track their training consistency for both strength and conditioning and mental performance training. These will be tracked and displayed for reference on a daily basis (e.g., FIG. 16, etc.), monthly basis (e.g., FIG. 17, etc.), and yearly basis (e.g., FIG. 18, etc.).

An eight product may include an advanced athlete tracking software (for coaches) that is utilized by a team's coaches to track and manage their team's training trends. The coaches may be provided with ability to monitor individual athlete's physical and mental training history: daily (e.g., FIG. 16, etc.), monthly (e.g., FIG. 17, etc.), and yearly (e.g., FIG. 18, etc.).

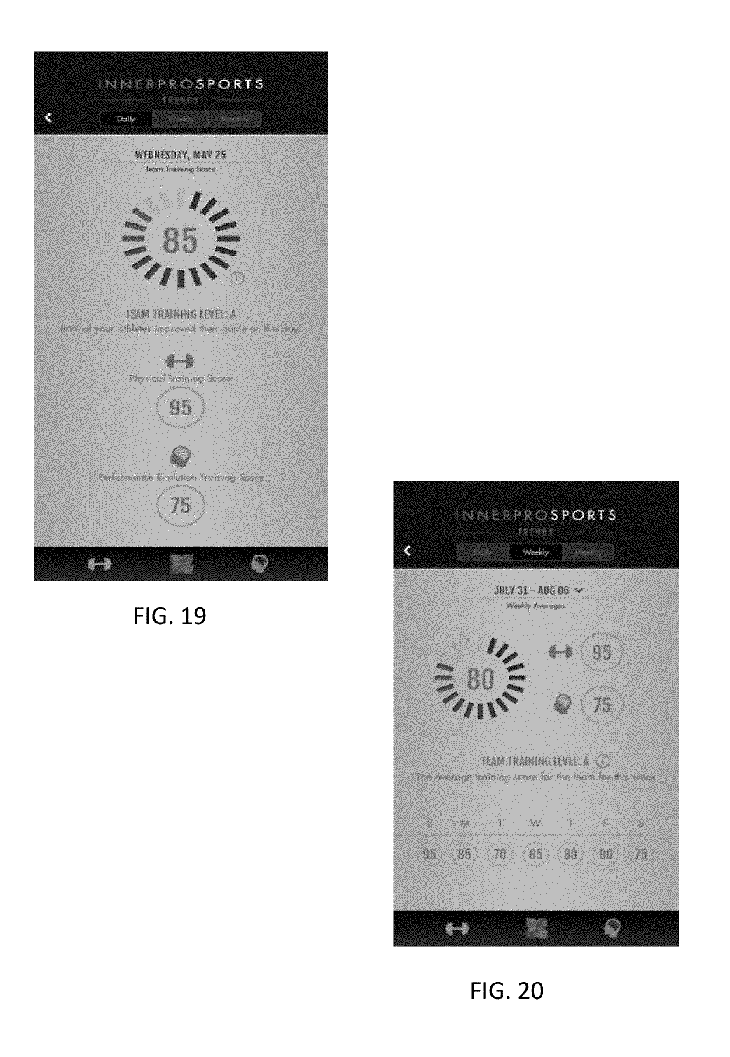

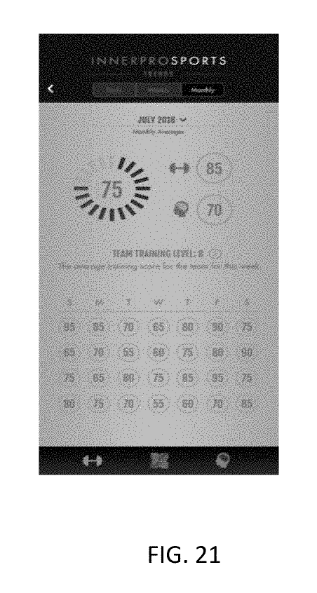

The coaches may be provided with the ability to determine how their entire team is trending in terms of physical and mental training. This may be seen on a daily basis (e.g., FIG. 19, etc.), monthly basis (e.g., FIG. 20, etc.), and yearly basis (e.g., FIG. 21, etc.).

An overall “Team Training Level” numerical and alphanumerical score may be given to the team each day.

Daily physical training numerical score may be calculated based on:

(# of athletes who have completed training)/(total number of athletes)=numerical score or percentage.

Daily performance evolution (mental) training numerical score ma be calculated based on:

(# of athletes who have completed training)/(total number of athletes)=numerical score (percentage).

Daily overall numerical training score may be based on an average of the physical and mental training scores.

(physical score+mental score)/2=overall numerical score

Overall weekly numerical training score may be based on an average of daily overall scores from the week.

Overall monthly numerical training score may be based on an average of daily overall scores from the month.

Alphanumerical score is calculated based on an overall numerical training score:
Applied Alphanumerical System:
A=80-100% Completion
B=70-79% Completion
C=60-69% Completion
D=50-59% Completion
F=<OR=49% Completion

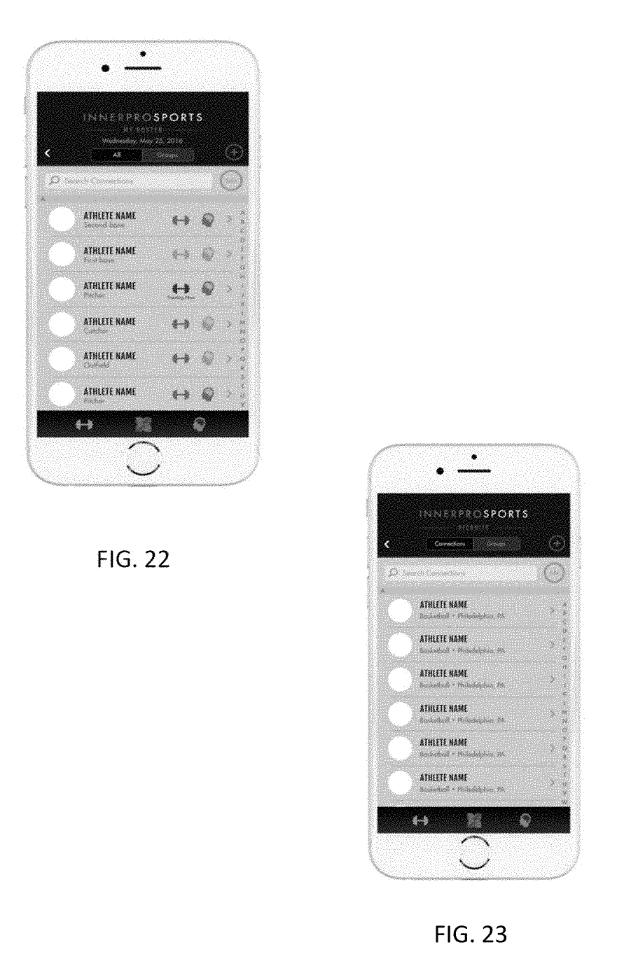

The coaches may be able to receive updates in real time on training inconsistencies and all injury situations (e.g., FIG. 22, etc.) The coaches may be able to connect with and monitor recruits' physical and mental training history (e.g., FIGS. 16, 17, 18, and 23, etc.).

In various exemplary embodiments, a training plan may be designed to meet the specific circumstances and needs of an individual athlete or athletes and can be delivered to the athlete(s), e.g., over the Internet, via smartphones, etc. The progress of the athlete(s) can be tracked dynamically, and the training plan(s) can be adjusted to meet the current needs of the athlete(s) in real time. In various exemplary embodiments, systems and methods for providing performance training and development, e.g., to an athletic coach, information describing past and/or current statuses of an individual athlete's and/or a team's training and performance.

In an example embodiment, a system for providing performance training and development may be configured to perform the following method. Based on a current profile of an individual athlete and rules for matching exercises with athlete profiles, the system determines a training plan specific to the individual athlete. Based on the training plan and a physical location in which the athlete is determined to be currently present, the system provides a training session electronically to the athlete, e.g., via a software application on the athlete's smart phone or other electronic device. The training session is configured to include exercises specific to the athlete and performable by the athlete at the physical location in which the athlete has been determined to be currently present. The system may receive, electronically from the athlete, feedback regarding the training session. The system may adjust the training session based on the feedback, and may make the adjusted training session electronically available in real time to the individual athlete in the same physical location. The system may also adjust the athlete's training plan in response to the feedback.

In various exemplary embodiments, the system may provide mental performance training as part of the training plan for an athlete. The mental performance training may be provided, e.g., to assist the athlete in attaining one or more performance goals included in the athlete's current profile. In an example embodiment, an athlete may undergo mental performance training in order to be able to achieve a target performance state of mind in which the athlete wishes to compete at an upcoming athletic event.

In an example embodiment, an athlete who uses a system for providing individual performance training may track his/her training plan, training sessions and progress over time, and/or may connect electronically with other athletes, etc., for example, to determine how the other athletes are progressing in their training plans. In some embodiments, a coach for a team to which an athlete belongs may access training information for each athlete on the team, e.g., to check on their training progress in real time while the athletes are on vacation or otherwise remote from where the team is based. Additionally or alternatively, a team coach may use training information for team members, e.g., to detect trends in how the team is progressing.

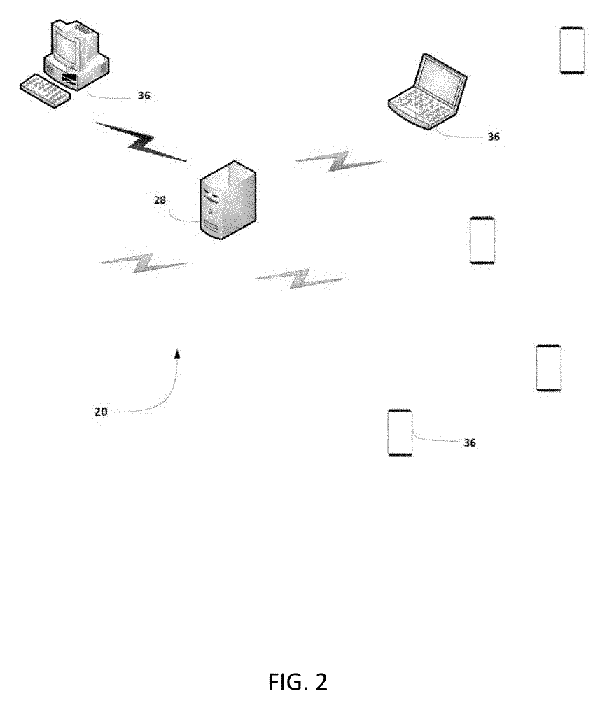

FIG. 2 illustrates an exemplary embodiment of a system 20 for providing individual performance training, the apparatus embodying one or more aspects of the present disclosure. The example system 20 is a client-server system (broadly, a communication network) in which one or more management computers 28 are configured for communication via the Internet with a plurality of user devices 36, e.g., smart phones, computers, tablets, notebooks, etc. In the present example embodiment, a single management computer 28 is shown. The management computer 28 includes and/or has access to one or more application databases.

Each user device 36 includes a user interface, e.g., a touch screen, a display screen and keypad or keyboard, etc., and a wireless interface whereby the user device 36 may perform wireless communication. The example management computer 28 is configured to perform as a server and the user devices 36 are configured to perform as clients of the server. A software application, which is installed on or otherwise made available to a given user device 36, provides access by the user device 36 via the management computer 28 to features and capabilities relating to performance training in accordance with aspects of the present disclosure. In various embodiments, a technology stack such as Cordova may be used to provide a user device 36 application. In various exemplary embodiments, a web-based administrative interface may be provided, e.g., on and/or through the management computer 28. In various exemplary embodiments, HTML, CSS, JS and/or other languages and/or scripting capabilities could be used to provide a web-based administrative interface. It will be understood by those knowledgeable in the art that various system features, functions and components may be provided in and/or by various numbers and/or configurations of computing and networking devices. Other or additional configurations of management and/or user devices and software could be used. For example, in some embodiments, a system for providing individual performance training may include a distributed peer-to-peer system on the Internet.

In various exemplary embodiments, the user devices 36 include smart phones, tablets, etc. of a plurality of individual athletes who use their devices 36 to access the management computer 28, e.g., to obtain training sessions and materials for use in improving their performance skills as athletes. The athletes, who may include college and/or high school students, typically live in and/or travel between locations that are remote from the management computer 28. Such locations may include home, school, gymnasium, track, playing field, etc. Other users of the system 20 may include one or more coaches of athletic teams having members who use the system 20 as further described below. Coaches also may use their user devices 36 to access the system 20. As further described below, the system 20 makes a coach platform available whereby coaches may track the performance training progress of athletes who use the system 20.

In the present example embodiment, the system 20 uses a current profile of an athlete and a set of rules for matching the athlete with specific exercises and training. In various embodiments, systems and methods provide a plurality of ways in which an athlete may control and participate in his/her own performance training. The example system 20 provides a strength and conditioning module, a mental performance training module, an athlete tracking module, and a platform whereby a coach may determine how his/her team athletes are progressing in their training. Other or additional modules may be provided in various embodiments.

An athlete may participate in training, e.g., in the following manner. An athlete signs in interactively with the system 20, e.g., using his/her user device 36. The athlete first provides information for a profile to be stored in the system 20 for the athlete. An example smart phone screen may display an example athlete profile including information describing the athlete's personal status and athletic status. For example, the athlete identifies his/her particular sport (e.g., baseball, football, tennis, etc.), his/her primary playing position (e.g., baseball catcher, pitcher, shortstop, etc.), age, training experience, injury history, season status (e.g., in-season, off-season, pre-season, etc.) estimated time to season transition, etc. The athlete also identifies one or more performance targets, which the system 20 may use to customize a training strategy for that athlete. For example, the athlete may specify a focus on strength, with a performance emphasis on lower body power, upper body strength, hip mobility and agility.

Strength and Conditioning

The foregoing personal information is stored in the athlete's profile and may be updated in the system 20, which maintains a profile for each athlete for use in customizing performance training for the particular athlete. For example, an athlete who plays baseball primarily as a catcher is provided with a training plan and training sessions focused on the movement demands for that position, and so trains differently, e.g., from a pitcher, shortstop, outfielder, etc. The system 20 determines a training plan having a length of time appropriate for the individual athlete. Such a plan may be, e.g., four, eight or twelve weeks long, although a given athlete may be provided with a training plan of another length. Training sessions are organized for the athlete based at least in part on the training plan. In various embodiments, the length and contents of a training plan may be adjusted, in real time and/or over time, for a given athlete depending on various factors such as the athlete's particular sport, the athlete's physical condition, etc.

Appropriate training session exercises are selected for the specific athlete, e.g., to keep the athlete healthy and to allow the athlete to build momentum on each training day. An athlete's playing schedule can be taken into account, e.g., when training sessions are assembled by the example system 20. For example and in some embodiments, where an athlete is in the off-season and the season begins at a specified time, exercises for that athlete are adjusted at training stages appropriate to allow the athlete to be in peak condition, and not worn down from intense training, at the start of the upcoming season.

After the system 20 has generated a profile and training plan for an athlete, the athlete may decide to perform a training session. When the athlete is ready to train, then the athlete activates the user interface of his/her user device 36 to obtain exercises from the system 20 for the training session. The system 20 refers to the athlete's current profile to determine the athlete's recent training history, e.g., whether the athlete has taken time off from training, whether the athlete has trained daily for a particular number of days, etc. Based on the current profile information, the system 20 may adjust the exercises to be performed in the upcoming training session. The system 20 may request further information from the athlete. For example, in a pre-workout process screen, the athlete may be asked to provide his/her most recent game status. The athlete may specify that he/she played a game the night before the training session. The athlete also is asked to describe his/her current soreness level in various parts of the body, and to provide his/her current energy level. The athlete may also be asked to identify the current location in which the training session is to take place, and to identify the exercise equipment available to the athlete at the current location. The athlete's training session may be adjusted in accordance with the information requested by the system 20 and provided by the athlete. It should be noted generally that information requested by the system 20, provided by the system 20 and/or entered into the system 20 may vary, as may the order in which such information is requested, provided, and/or entered.

When information obtained by the system 20 is sufficient for use in generating and/or adjusting a training session, the athlete may receive a display on his/her user device 36 of an overview of the training session. The overview may list the training session focus, equipment, and exercises from warm-up through cool-down. The overview may also show what improvements are to be gained from the session. When the athlete uses equipment that has a weight associated with it, the weight may be entered into the system 20 for use in generating future training plans and/or training sessions.

The training session may be shown in text mode and/or in video mode. In text mode, the training session exercises are assigned time durations in seconds and the athlete is to move through the exercises within the time allowed. The athlete can select a video for display that demonstrates how to perform a selected exercise properly and what the benefits are to performing the selected exercise. In video mode, the athlete follows along with the coach, who demonstrates in the video how the exercises should be performed.

When the athlete has finished the training session, the athlete logs his/her efforts in the system 20 and provides feedback as requested by the system 20. If, for example, the athlete indicates that a specific part of the training session was too difficult, then future training sessions may be adjusted accordingly by the system 20. The athlete may receive a training summary and a breakdown of training for that day. The athlete may activate portions of the user device 36 screen to display the benefits that accrued from the day's training session. The system 20 may also provide a library of videos discussing how and why an athlete exercises, how to select appropriately sized equipment, etc.

Mental Performance Training

The example system 20 also provides a platform for mental training of athletes. For example, an individual athlete may access a plurality of mental performance training modules through his/her user device 36. An example menu may include three mental performance training modules that are available. An “Own Your Psychology” module provides information, e.g., in video form, for helping the athlete establish a vision for his/her game and to understand what the athlete needs to believe in to make the vision a reality. Next, the athlete may work on how to determine what drives the athlete and how to use that drive as “fuel” to elevate the athlete's work ethic. The athlete may be assisted in learning how to focus on his/her daily actions, to take consistently the actions that work to turn the athlete's vision into reality. A “Create Your Game” capability accessible on the athlete's user device 36 provides a tool that the athlete may use daily to condition the mind of the athlete for success on a daily basis. The “Create Your Game” tool may be used before the athlete begins his/her day to prompt the athlete to focus on what is important to the athlete and why it is important. The athlete may select, enter and store in the system 20 one or more (e.g., 1 to 3) targets to accomplish that day to improve the athlete's game. That evening, the athlete may give himself/herself a grade on how well the athlete accomplished the selected targets. The athlete may store the grade in the system 20 and is the only person to see the grade.

An “Own Your State” module helps the athlete learn how to develop the skill of generating his own states of mind. The athlete is helped to identify the state of mind in which the athlete performs at his/her very best. This state of mind becomes the athlete's target performance state of mind and is the state of mind for the athlete to aim for before and during competition. A “Game Day” tool is provided whereby the athlete can prepare his/her mind and body, e.g., before a game or other competition. The system 20 may provide, e.g., a video of the athlete's human coach, who leads the athlete through a dynamic warmup. The athlete may then be prompted, e.g., by a video that includes a human coach, to generate the athlete's target performance state of mind. The athlete has the option to load and play videos of highlights of the athlete's past playing to help in generating the target performance state of mind. The module may display the athlete's target performance state of mind (“Powerful” in the present example) and an incantation for the athlete to recite, to prepare the athlete to compete.

An “Own Your Strategy” module provides strategies and insights to the athlete to assist the athlete in improving his/her game further. Topics of instruction may include building skills, slump busting, etc.

Athlete Tracking

In the example system 20, an athlete's training sessions are stored and are later accessible by the athlete. An athlete can check his/her training daily, monthly and yearly. The athlete thus may watch his/her investment in building strength and conditioning, in detail and/or over time. The athlete's mental performance training also is stored in the system 20 and can be accessed by the athlete, who can see, e.g., all days in which he/she completed the morning and evening rituals described above. The athlete can also see a graph of the daily grades the athlete gave himself/herself regarding achievement of daily targets as described above. Additionally or alternatively, the athlete can connect via a user device 36 with other users of the system 20, e.g., other team members, friends who use the system 20, coaches, scouts, etc. The athlete can see how his/her connections are building their games, how many times the athlete's connections accessed the athlete's profile, etc.

Coach's Platform

In various exemplary embodiments, when members of an athletic team become users of the example system 20, the team's coaching staff may be given access to a software platform of the system 20 whereby a coach may see the strength, conditioning and mental performance training data and progress of each team member. Accordingly, a team coach and the team's athletes have the same knowledge base, in real time, regarding the athletes' statuses and progress. In some embodiments, where a college coach is a scout, the coach can use the system 20 to track recruits who are connected in the system 20. A coach can see, in real time, which team members have performed their strength, conditioning and mental training, even when team members are, e.g., off-campus for several months. The coach can view an athlete's training history over time. Coaches can also use the data from the system 20 to discover trends in how teams are performing.

In various exemplary embodiments, a player development platform (PDP) is configured to help teams improve competitive performance, e.g., by organizing, managing, and tracking most if not all areas of player development, e.g., from one centralized location. Such areas include but are not necessarily limited to strength and conditioning, mental performance training, injury prevention, rehabilitation, physical therapy, and nutrition. An example player development software platform may be configured as a hub accessible to a plurality of users, including an athlete, coaching staff (e.g., a head coach, assistant coaches, etc.), medical staff (e.g., a team physician, an athletic trainer, a physical therapist, etc.), a strength and conditioning coach, and a nutritionist. In some embodiments, users who are involved in any one of the player development areas are able to communicate with user(s) involved in any of the other player development area(s). For example, strength and conditioning recommendations made by a strength and conditioning coach relative to a given player and/or team can be circulated through and/or around the hub to other user(s), e.g., to medical staff for recommendations and/or comments. Additionally or alternatively, observations by a medical staff member regarding, e.g., a given athlete can be circulated, e.g., to coaching staff, to nutritionist(s), and/or to the athlete himself/herself. Information regarding a given athlete and/or team thus can circulated around and/or through the hub, so that the information can reach all those who are authorized by the player development platform to receive and use the information in organizing, managing and/or tracking player development. The hub can be customizable in accordance with the particular circumstances of one or more users. For example, a given team of users may utilize some, but not all, of the player development areas.

Various types of users may have various roles in using various player development software platform embodiments. A user who has a given role thus may utilize hardware and/or software different from hardware and/or software used by another user who has a different role. One such role is that of an athlete, who in various embodiments may access a level of coaching that is optimal and also individually designed for that player. An athlete may further access such coaching at any time of the night and/or day. Additionally the athlete may monitor his or her physical and mental training and receive assistance in injury rehabilitation and/or physical therapy. In various embodiments, an athlete may use a software application, e.g., interactively, on a mobile device such as a smart phone, tablet, and/or laptop and/or on a desktop computer.

Another user may be a coaching staff member such as a head or assistant coach. A coaching staff member may monitor an athlete's physical and mental training history. Additionally or alternatively, a coaching staff member may determine how their team is trending in terms of their physical and mental training and/or may receive updates in real time on any training inconsistency and/or injury situation. In various embodiments, a coaching staff member may use a software application, e.g., interactively, on a smart phone, tablet, laptop and/or desktop computer. In some embodiments, a coaching staff member may use the same software application used by an athlete whom the coaching staff member is coaching.

Another user may be a strength and conditioning coach, who may create, distribute and/or manage customized training programs for athletes, e.g., on a mass scale. Such a coach may also make quick and easy changes to training plans on a mass scale, may monitor an athlete's training history, and/or may obtain real-time updates on soreness, injuries and exercises that may be too difficult to perform. A strength coach also may wish, e.g., to know exactly what medical staff is having a given athlete do during rehab or physical therapy situations. Thus a strength coach may use software provided in the player development platform that is specific to the needs of, and supportive of the functions of, a strength coach. In various embodiments, a user dashboard may be provided that provides customized training programs created, distributed and managed by strength and conditioning coaches. Such programs may be distributed to an athlete, e.g., via the player development platform application provided to the athlete. Additionally or alternatively, a strength coach may access a library of specific training programs and/or individual exercises.

In some embodiments, dynamic training programs may be provided, e.g., by an expert strength coach. Such programs may dynamically adjust to a given athlete's needs, e.g., on a daily basis. In various embodiments, an application engine may access a database in real time, e.g., using Firebase and/or another application platform, to determine whether a training program has been built for a given athlete. If yes, then an appropriate training session is sent to the athlete. If no training program has been built, the engine may access cloud data storage to build a new master training program for the athlete. When a new training session is built for a particular athlete, the session may be sent to that athlete. The new session may also be stored in the real-time-accessible database for future use by other athletes. The real-time-accessible database may be, e.g., a SQL database, although other or additional database platforms could be used.

Medical staff may have roles in supporting athlete development via a player development platform. Medical staff may include, e.g., a team physician, an athletic trainer, a physical therapist, etc. who may wish and/or need to be notified of any athlete injuries, to create, distribute and manage rehab and physical therapy strategies, and to see an athlete's physical training history. In various embodiments, a player development platform provides software specific to support the performance and needs of such medical staff.

In various embodiments, nutritionist(s) may have roles in supporting athlete development via a player development platform. Thus software may be provided, e.g., to support the creation and/or distribution of customized meal plans and supplementation in alignment with a given athlete's physical training strategy.

In various embodiments, a library provides a plurality of educational videos, e.g., on psychology, state and strategy. An athlete may implement what he/she has learned, e.g., via “create your game” and “generate state” tools provided on the athlete's computing device by the software application.

In various embodiments, a medical staff member for a team may use medical software provided in the player development platform. Such medical software may be used to create, distribute and/or manage customized rehabilitation and/or physical therapy programs, which may be distributed to an athlete via the software application on the athlete's computing device. A medical staff member may access the database of specific training programs and individual exercises.

In various embodiments, recommendations for macrobiotics and/or supplements may be dynamically provided by the player development platform software based, e.g., on an athlete's current strength and conditioning program. Additionally or alternatively, a team's nutritionist may create, distribute and/or manage customized nutrition strategies and meal plans, which may be distributed to an athlete via the software application on the athlete's computing device. A nutritionist may access a library of nutrition and supplementation information provided by the player development platform.

The foregoing systems and methods can provide levels of performance training that can meet or exceed the quality of training that individual athletes would receive from a human coach. No human coach is able to provide one-on-one coaching sessions to members of a team when the team members are geographically dispersed, on different time schedules, and in different states of conditioning. Further, human coaches often do not have the expertise to select, at a training site and at the time of a training session, the most appropriate exercises and training methods for a particular athlete, when factors that affect the athlete's exercising and training may vary from day to day. In contrast, performance training in accordance with various embodiments of the disclosure can be focused on a single day and can be structured to automatically account for factors that include but are not limited to the athlete's current location, current physical condition and motivation to succeed as an athlete. Therefore the training can be made more consistent for the individual athlete. In the foregoing systems and methods, rules are used and updated for automatically structuring and adjusting training session exercises to match the individual athlete and his/her current circumstances. Feedback from an athlete as to a training session can be used not only to adjust the athlete's training session and/or plan, but also to update the rules used to determine training sessions. Thus feedback from one athlete can be used to influence the generation of training sessions for other athletes. Because the rules are structured to take a specific athlete and his/her current situation automatically into account, training session exercises can be structured to automatically take into account various factors that a human coach would not always necessarily be able to take into consideration.

It should be noted generally that although embodiments are described herein with reference to athletes and improvement of athletic skills by teams of athletes, the disclosure is not so limited. Embodiments are contemplated in which other or additional personal skills, capabilities, conditions, etc. may be improved through use of training apparatus, methods, systems, materials, etc. described herein. For example, aspects of the disclosure may be practiced in relation to assisting people who wish to lose weight, begin exercising for the first time, get ready for a marathon, etc. It also should be noted generally that the content and sequences of views, user-system interactions, and substance and presentation of data can differ in various embodiments in accordance with aspects of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for providing performance training and development, the system comprising a communication network with a central distribution hub configured to allow two-way electronic communication between members of a team including an athlete and at least two or more other team members including a coaching staff team member, a medical staff team member, a nutritionist team member, and strength and conditioning coach team member.

2. A method for providing performance training and development, the method comprising enabling two-way communication via a central distribution hub of a communication network between members of a team including an athlete and at least two or more other team members including a coaching staff team member, a medical staff team member, a nutritionist team member, and strength and conditioning coach team member.
